(19) United States
(12) Patent Application Publication
(10) Pub. No.: US 2011/0153100 A1
(43) Pub. Date: Jun. 23, 2011

(54) DEMAND RESPONSE APPLIANCE POWER CONSUMPTION FEEDBACK

(75) Inventors: John K. Besore, Louisville, KY (US); Timothy Dale Worthington, Louisville, KY (US); Michael F. Finch, Louisville, KY (US); Jeff Donald Drake, Louisville, KY (US); Natarajah Venkatakrishnan, Louisville, KY (US)

(73) Assignee: General Electric Company

(21) Appl. No.: 12/644,552

(22) Filed: Dec. 22, 2009

(51) Int. Cl. G06F 1/26

(52) U.S. Cl. 700/291

(57) ABSTRACT

A system is provided for determining and displaying the cost of consuming power comprising an appliance including one or more power consuming functions wherein each of the one or more power consuming functions includes an associated power consumption amount. The system further provides a home energy management system (HEM) including a controller in communication with the appliance and configured to provide the HEM with the associated power consumption amount of each of the one or more power consuming functions. The controller is in signal communication with an associated utility, wherein the controller receives and processes a signal from the associated utility indicative of current cost of supplied energy. The controller being configured to convert the current cost of supplied energy into a power consumption cost of the associated power consumption amount of the one or more power consuming functions.

### BACKGROUND

This disclosure relates to energy management, and more particularly to electrical device control methods and electrical energy consumption systems. The disclosure finds particular application to energy management of home appliances, for example, dishwashers, clothes washers, dryers, HVAC systems, etc.

Many utilities are currently experiencing a shortage of electric generating capacity due to increasing consumer demand for electricity. Currently utilities generally charge a flat rate, but with increasing cost of fuel prices and high energy usage at certain parts of the day, utilities have to buy more energy to supply customers during peak demand. Consequently, utilities are charging higher rates during peak demand. If peak demand can be lowered, then a potential huge cost savings can be achieved and the peak load that the utility has to accommodate is lessened. In order to reduce high peak power demand, many utilities have instituted time of use metering and rates which include higher rates for energy usage during on-peak times and lower rates for energy usage during off-peak times. As a result, consumers are provided with an incentive to use electricity at off-peak times rather than on-peak times. And to reduce overall energy consumption of appliances at all times.

Presently, to take advantage of the lower cost of electricity during off-peak times, a user must manually operate power consuming devices during the off-peak times. This is undesirable because a consumer may not always be present in the home to operate the devices during off-peak hours. This is also undesirable because the consumer is required to manually track the current time to determine what hours are off-peak and on-peak.

One proposed third party solution is to provide a system where a controller “switches” the actual energy supply to the power consuming device on and off. However, there is no active control beyond the mere on/off switching. There are also currently different methods used to determine when variable electricity-pricing schemes go into effect. There are phone lines, schedules, and wireless signals sent by the electrical utility company. One difficulty is that different electrical companies use different methods of communicating periods of high electrical demand to their consumers. Other electrical utility companies simply have rate schedules for different times of day.

Therefore, there is a need to provide a system that can automatically operate power consuming devices during off-peak hours in order to reduce consumer's electric bills and also to reduce the load on generating plants during on-peak hours. Active and real time communication of energy costs of appliances to the consumer will enable informed choices of operating the power consuming functions of the appliance.

Electrical utilities moving to an Advanced Metering Infrastructure (AMI) system will need to communicate to appliances, HVAC (i.e. room or whole house), water heaters, etc. in a home or office building. All electrical utility companies (more than 3,000 in the US) will not be using the same communication method to signal in the AMI system. Similarly, known systems do not communicate directly with the appliance using a variety of communication methods and protocols, nor is a modular and standard method created for communication devices to interface and to communicate operational modes to the main controller of the appliance. Although conventional WiFi/ZigBee/PLC communication solutions are becoming commonplace, this disclosure introduces numerous additional lower cost, reliable solutions to indicate and communicate cost of energy in appliances or other users of power. This system may also utilize the commonplace solutions as parts of the communication protocols.

### BRIEF DESCRIPTION

The present disclosure can determine and display the cost of consuming power for an appliance including one or more power consuming functions.

In one aspect of the disclosure, a system for determining and displaying the cost of consuming power is provided comprising an appliance including one or more power consuming functions wherein each of the one or more power consuming functions includes an associated power consumption amount. The system further provides a home energy management system (HEM) including a controller in communication with the appliance and configured to provide the (HEM) with the associated power consumption amount of each of the one or more power consuming functions. The controller is in signal communication with an associated utility, wherein the controller receives and processes a signal from the associated utility indicative of current cost of supplied energy. The controller being configured to convert the current cost of supplied energy into a power consumption cost of the associated power consumption amount of the one or more power consuming functions.

In another aspect of the disclosure, a method of determining the cost of consuming power is provided comprising: associating one or more power consuming functions of an appliance with a corresponding power consumption amount; connecting one or more power consuming functions with a home energy management system (HEM); and, sending a signal from an associated utility to the HEM, wherein the HEM includes a controller in signal communication with the associated utility. The controller receives and processes a signal from the associated utility indicative of current cost of supplied energy. The method further comprises operating the appliance in the one or more power consuming functions; and, converting, through the controller, the current cost of supplied energy into a power consumption cost of the one or more power consuming functions wherein the power consumption cost is communicated to the home energy management system.

In still another aspect of the disclosure, a method of computing power consumption cost of an appliance is provided comprising: connecting one or more power consuming functions with a home energy management system (HEM); and, sending a signal from an associated utility to the HEM, wherein the HEM includes a controller in signal communication with the associated utility. The controller receives and processes a signal from the associated utility indicative of current cost of supplied energy. The method further comprises operating the appliance in the one or more power consuming functions; converting, through the controller, the current cost of supplied energy into a power consumption cost of the one or more power consuming functions wherein the power consumption cost is communicated to the home energy management system; and, multiplying the power consumption cost of each of the one or more power consuming functions by a respective cycle time to calculate the energy cost of each of the one or more power consuming functions.

An advantage of the present disclosure is the ability to enable the consumer or user an opportunity to monitor, look-up, calculate, track, compare, and/or record the power consumption cost of each of the one or more power consuming functions.

Another advantage is the ability to monitor, calculate, compare, and contrast the power consumption cost of functions and features within the appliance and/or unit at various energy levels. Comparing and contrasting can include from one function to another function and can be annualized or multiplied by a pre-selected time frame.

Still other features and benefits of the present disclosure will become apparent from reading and understanding the following detailed description.

### BRIEF DESCRIPTION OF THE DRAWINGS

FIG. 1 is a schematic illustration of a home energy management system.

### DETAILED DESCRIPTION

The central controller handles energy management between the utility and home appliances, lighting, thermostat/HVAC, etc. with customer choices incorporated in the decision making process. The controller may include determining and displaying energy consumption based on particular power consuming functions/features. It is to be appreciated that each power consuming function includes an associated power consumption amount. The appliance can include, for example, a current transformer for determining the associated power consuming amounts.

To be described hereinafter, a system for determining and displaying the cost of consuming power is provided and comprises an appliance including one or more power consuming functions wherein each of the one or more power consuming functions includes an associated power consumption amount. A home energy management system (HEM) can be connected with the appliance and can include a controller in communication with the appliance and configured to provide the HEM with the associated power consumption amount of each of the one or more power consuming functions. The controller is in signal communication with an associated utility wherein the controller receives and processes a signal from the associated utility indicative of current costs of supplied energy. The controller can be configured to convert the current cost to supply energy into a power consumption cost of the associated power consumption amount of the one or more power consuming functions. In one embodiment, the associated power consumption amount can be determined by using a current transformer connected with the one or more power consuming functions. The power consumption cost of each of the one or more power consuming functions can be tracked and recorded by the home energy management system. It is to be appreciated that the present disclosure provides the ability to enable the consumer or user an opportunity to monitor, look up, calculate, track, compare, and/or record the power consumption cost of each of the one or more power consuming functions. The consumer also has the ability to monitor, calculate, compare, and contrast the power consumption cost of the appliance functions and features at various energy levels. For example, the power consumption cost can be compared and contrasted from one function to another function as the user makes functional selections on the appliance. In addition, the display can also analyze cost comparisons or display the cost comparisons based on a usage or preselected timeframe.

Depending on which particular appliance is being monitored, the one or more power consuming functions can comprise the following: power on, idle, wash cycle, rinse cycle, fill cycle, pump out cycle, spin cycle, cool, defrost, bake, broil, self-clean cycle, microwave, exhaust fan, and dry cycle. The power consumption cost of each of the one or more power consuming functions can be multiplied by a respective cycle time to calculate the energy cost of each of the one or more associated power consuming functions. The home energy management system can compile the energy cost of each of the one or more power consuming functions in order to provide a total energy cost of the one or more power consuming appliances. The actual power consumption cost of each of the one or more power consuming functions can be communicated in real time. The power consumption cost of each of the one or more power consuming functions can be summed and reported as a total for the respective appliance.

Alternatively, in another embodiment, the power consumption cost can be estimated by the appliance using information supplied to the HEM (i.e. Table 1) regarding the associated power consumption amount of the one or more power consuming functions. The associated power consumption amount of each of the one more power consuming functions is determined by using a table of power load values pre-loaded into a memory of the HEM and the amount of time the respective load was in the “ON” state. As one illustrative example, Table 1 displays possible functional options for a clothes washer. The operator can first select normal (N), light (L), or heavy (H) feature for each of the wash (W) and rinse (R) cycles. The operator can then select the water temperature of hot (H), warm (W), or cold (C). The combination of the selected wash, rinse, and associated spin cycles will each comprise a certain amount of power consumption, i.e. pre-loaded table of power consumption values associated with each power consuming function. At the same time, a water level can be selected to accompany the wash and rinse cycles (low (L), medium (M), and high (H)). The selected wash, rinse, water temperature, and water level will result in a total power consumption amount. This power consumption can be displayed and compared against, for example, a standard or normal (i.e. average) power consumption in order for the consumer to compare and contrast the selected features. The difference in power consumption between the selected features and the ‘average’ features can be annualized (based on historical consumer usage data) in order for the consumer to make informed decisions of whether to run the appliance with the selected features or modify the selected features. Once the appliance runs with the selected features, the HEM can monitor, look-up, calculate, track, compare, and/or record the power consumption cost of each of the selected power consuming features and compile the power consumption of a complete appliance functional cycle (i.e. load of wash).

TABLE 1
APPLIANCE FUNCTION/FEATURE

| | | | | | | | | | | WATER |
|---|---|---|---|---|---|---|---|---|---|---|
| TEMP | NW | NR | NS | LW | LR | LS | HW | HR | HS | LEVEL |
| HOT | NWH | NRH | NS | LWH | LRH | LS | HWH | HRH | HS | L |
| WARM | NWW | NRW | NS | LWW | LRW | LS | HWW | HRW | HS | M |
| COLD | NWC | NRC | NS | LWC | LRC | LS | HWC | HRC | HS | H |

The present disclosure provides a method of determining the cost of consuming power comprising associating one or more power consuming functions of an appliance with a corresponding power consumption amount. The method further provides for connecting the one or more power consuming functions with the home energy management system. A signal can be sent with an associated utility through the HEM wherein the HEM includes a controller in signal communication with the associated utility. The controller receives and processes a signal from the associated utility indicative of current costs and energy. The appliance is operated using one or more power consuming functions. The controller converts the current cost to supply energy into a power consumption cost of the one or more power consuming functions wherein the power consumption cost is communicated to the home energy management system. The appliance can include a current transformer for measuring in real time the power consumption amount of the one or more power consuming functions, or can translate a pre-loaded table of power consumption values associated with each of the one or more power consuming functions.

The present disclosure further provides a method of controlling power consumption costs of an appliance comprising connecting one or more power consuming functions with the home energy management system. A signal can be sent from an associated utility to the HEM wherein the HEM includes a controller in signal communication with the associated utility. The controller receives and processes a signal from the associated utility indicative of the current cost of supplying energy. The appliance is then operated in the one or more power consuming functions. The controller converts the current cost of supplying energy into a power consumption cost of the one or more power consuming functions wherein the power consumption cost is communicated to the home energy management system. The power consumption cost of each of the one or more power consuming functions can be multiplied by a respective cycle time in order to calculate the energy cost of each of the one or more power consuming functions.

An energy savings mode of an appliance can thereby be controlled or measured based on consumer selections and utility energy costs. How much energy the appliance consumes is based on selected features and real time cost of energy being supplied to the appliance.

A method is provided for constructing an appliance designed to perform any key function, the appliance comprises several mechanical and electrical elements controlled by a main controller. This main controller has a port for receiving information regarding the operational state of the appliance. The port also has a user interface or switch which could be used to override the information received by the controller through the port. Two-way or one-way communication devices may be connected to the port. These communication devices will receive signals from a remote controller, process those signals and as a result communicate an operational state to the main controller of the appliance. This operational state is communicated to the main controller by one or more remote controllers in a specific format determined by the appliance. These signals from the remote controller(s) could be based on a variety of communication methods and associated protocols. On receiving the operational state signal, the appliance main controller causes the appliance to run a predetermined operational mode. These operational modes are designed into the appliance(s) and result in different resource consumption levels or patterns, even delaying use. Resources could include energy, water, air, heat, sunlight, time, etc. In future appliance models, the consumer might be given the authority to modify the appliance responses to a given rate signal. The consumer would be presented a “check box” of potential response modes and allowed to choose within set parameters. For instance, the consumer might be allowed to choose the amount of temperature adjustment a refrigerator will make in response to a high utility rate, and the respective difference in power consumption could be displayed to the consumer.

The user interface may also incorporate suggested energy saving tips or show energy usage, or provide an indicator during on-peak mode, or provide a counter to illustrate the energy impact of door opening, or display an energy calculator to the consumer to serve as a reminder of the impact of certain selections/actions on energy use or energy conservation.

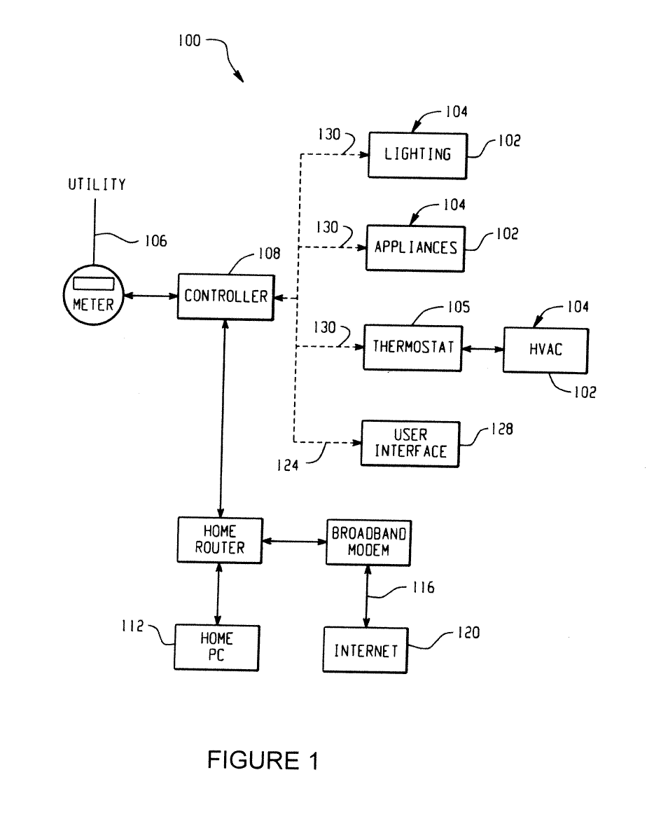

An exemplary embodiment of a home energy management system 100 having one or managed appliances 102 is schematically illustrated in FIG. 1. The appliances 102 each comprise at least one power consuming feature/function 104. The HVAC appliance 102 can include an internal or external thermostat 105. The home energy management system (HEM) 100 is operatively associated with the power consuming features/functions 104. The HEM 100 can include a controller or micro computer which is programmed to selectively control the energization of the power consuming features/functions 104. The HEM 100 is configured to receive and process a signal 106 from an associated utility, whereby the HEM 100, through the controller 108, is in signal communication with the associated utility. The controller 108 is configured to receive and process the signal 106 from the associated utility.

The HEM 100 can operate one or more associated appliances along with respective one or more power consuming functions 104, and monitor, calculate, look-up power consumption values, compare, and contrast the power consumption cost of functions and features within the appliance and/or unit at various energy levels. Comparing and contrasting can include from one function to another function and can be annualized or multiplied by a pre-selected time frame.

Appliances without a full interactive user interface, i.e. display, can be troublesome to enable the ability to actively monitor the power consumption of user selected appliance features. This disclosure allows the user to use, for example, a home computer 112 to track energy consumption of all appliances so the user can make informed choices regarding the functional features of the appliances. The look-up values can be downloaded 116 from the interne 120, and/or can be communicated 124 to the HEM 100 via a user interface 128 at the appliance. Alternatively, the associated power consumption amount can be determined from a current transformer 130 measuring the actual power consumption of each of the one or more power consuming functions. It is to be appreciated that information is being received, manipulated, and communicated by the computer 112 to and from the controller 108 and the interne 120.

Appliances can be delayed in their operation, rescheduled for a later start time, and/or altered in their functioning/features in order to reduce energy demands. The effects of these changes to operation will impact energy consumption. This impact can be displayed to the consumer and monitored/recorded by the HEM. Some appliances lend themselves to an altered operation due to their functionality. For example, dishwashers, clothes washers, and clothes dryers all have the capacity to run as needed because demand on these appliances is either not constant and/or the functions of these appliances are such that immediate response is not necessary. As one illustrative example, a dishwasher that has been loaded during the daytime, i.e., on-peak demand period hours, can be programmed to start its operations for a later, albeit off-peak demand hours. It is to be appreciated that on-peak and off-peak demand hours can correspond to high utility costs and relatively low utility costs ($/kilowatt), respectively. The change to off-peak demand hours, and the associated energy savings, can be displayed to the consumer.

A control method in accordance with the present disclosure comprises communicating with an associated utility and receiving and processing the signal indicative of at least a current utility cost, determining a power consumption cost of a first series of selected features, displaying the power consumption cost of the first series of selected features, changing the first series of selected features to a second series of selected features, and, determining a power consumption cost of the second series of selected features and comparing to the first cost of selected features. The operation of the appliances 102, i.e. selected series of features, may vary as a function of a characteristic of the supplied energy, e.g., availability and/or price.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A system for determining and displaying the cost of consuming power comprising:
an appliance including one or more power consuming functions wherein each of the one or more power consuming functions includes an associated power consumption amount;
a home energy management system (HEM) including a controller in communication with the appliance and configured to provide the (HEM) with the associated power consumption amount of each of the one or more power consuming functions;
the controller in signal communication with an associated utility, wherein the controller receiving and processing a signal from the associated utility indicative of current cost of supplied energy; and,
the controller being configured to convert the current cost of supplied energy into a power consumption cost of the associated power consumption amount of the one or more power consuming functions.

2. The appliance according to claim 1, wherein the associated power consumption amount is determined from a current transformer.

3. The appliance according to claim 2, wherein the power consumption cost of each of the one or more power consuming functions is tracked and recorded by the home energy management system.

4. The appliance according to claim 3, wherein each of the one or more power consuming functions is selected from the group consisting of power on, idle, wash cycle, rinse cycle, fill cycle, pump out cycle, spin cycle, cool, defrost, bake, broil, self-clean cycle, microwave, exhaust(fan) and dry cycle.

5. The appliance according to claim 3, wherein the power consumption cost of each of the one or more power consuming functions is multiplied by a respective cycle time to calculate the energy cost of each of the one or more power consuming functions.

6. The appliance according to claim 5, wherein the energy cost of each of the one or more power consuming functions is summed by the home energy management system to provide a total energy cost of one or more power consuming appliances.

7. The appliance according to claim 2, wherein the power consumption cost of each of the one or more power consuming functions is communicated in real time.

8. The appliance according to claim 1, wherein the power consumption cost of each of the one or more power consuming functions is summed and reported as a total for the appliance.

9. The appliance according to claim 1, wherein the power consumption cost is estimated by the appliance using the associated power consumption of one or more power consuming functions.

10. The appliance according to claim 1, wherein the associated power consumption amount of each of the one more power consuming functions is determined by using a table of power load values pre-loaded into a memory of the HEM and the amount of time the respective load was in the “ON” state.

11. A method of determining the cost of consuming power comprising:
associating one or more power consuming functions of an appliance with a corresponding power consumption amount;
connecting one or more power consuming functions with a home energy management system (HEM);
sending a signal from an associated utility to the HEM, wherein the HEM includes a controller in signal communication with the associated utility;
the controller receiving and processing a signal from the associated utility indicative of current cost of supplied energy;
operating the appliance in the one or more power consuming functions; and,
converting, through the controller, the current cost of supplied energy into a power consumption cost of the one or more power consuming functions wherein the power consumption cost is communicated to the home energy management system.

12. The method according to claim 11, wherein the appliance includes a current transformer for measuring the power consumption amount of the one or more power consuming functions.

13. The method according to claim 11, wherein the power consumption cost of each of the one or more power consuming functions is tracked and recorded by the home energy management system.

14. The method according to claim 11, wherein each of the one or more power consuming functions is selected from the group consisting of power on, idle, wash cycle, rinse cycle, spin cycle, fill cycle, pump out cycle, cool, defrost, bake, broil, self-clean cycle, microwave, exhaust fan, and dry cycle,

15. The method according to claim 11, wherein the power consumption cost of each of the one or more power consuming functions is multiplied by a respective cycle time to calculate the energy cost of each of the one or more power consuming functions.

16. The method according to claim 15, wherein the energy cost of each of the one or more power consuming functions is summed by the home energy management system to provide a total energy cost of one or more power consuming appliances.

17. The method according to claim 11, wherein the power consumption cost of each of the one or more power consuming functions is communicated in real time.

18. The method according to claim 11, wherein the power consumption cost of each of the one or more power consuming functions is summed and reported as a total for the appliance.

19. The appliance according to claim 11, wherein the power consumption cost is estimated by the appliance using information supplied to the HEM regarding the associated power consumption amount of one or more power consuming functions.

20. The appliance according to claim 11, wherein the associated power consumption amount of each of the one more power consuming functions is determined by using a table of power load values pre-loaded into a memory of the HEM and the amount of time the respective load was in the “ON” state.

21. A method of computing power consumption cost of an appliance comprising:
connecting one or more power consuming functions with a home energy management system (HEM); and,
sending a signal from an associated utility to the HEM, wherein the HEM includes a controller in signal communication with the associated utility;
the controller receiving and processing a signal from the associated utility indicative of current cost of supplied energy;
operating the appliance in the one or more power consuming functions;
converting, through the controller, the current cost of supplied energy into a power consumption cost of the one or more power consuming functions wherein the power consumption cost is communicated to the home energy management system; and,
multiplying the power consumption cost of each of the one or more power consuming functions by a respective cycle time to calculate the energy cost of each of the one or more power consuming functions.

22. The appliance according to claim 21, wherein the power consumption function includes a current transformer for measuring the power consumption.

23. The method according to claim 22, wherein the power consumption cost of each of the one or more power consuming functions is tracked and recorded by the home energy management system.

24. The method according to claim 22, wherein each of the one or more power consuming functions is selected from the group consisting of power on, idle, wash cycle, rinse cycle, spin cycle, fill cycle, pump out cycle, cool, defrost, bake, broil, self-clean cycle, microwave, exhaust fan, and dry cycle.

25. The method according to claim 22, wherein the energy cost of each of the one or more power consuming functions is summed by the home energy management system to provide a total energy cost of one or more power consuming appliances.

26. The method according to claim 22, wherein the power consumption cost of each of the one or more power consuming functions is communicated in real time.

27. The method according to claim 22, wherein each of the one or more power consuming functions is selected from function idle and function on.

28. The appliance according to claim 22, wherein the power consumption cost is estimated by the appliance using information supplied to the HEM regarding the associated power consumption amount of one or more power consuming functions.

29. The appliance according to claim 21, wherein the associated power consumption amount of each of the one more power consuming functions is determined by using a table of power load values pre-loaded into a memory of the HEM and the amount of time the respective load was in the “ON” state.
